(19) United States
(12) Patent Application Publication
(10) Pub. No.: US 2018/0211299 A1
(43) Pub. Date: Jul. 26, 2018

(54) METHOD FOR MANAGING VEHICLE AND CUSTOMER RELATED INFORMATION BETWEEN A DEALERSHIP, A MOTOR VEHICLE DEPARTMENT, AND A BUYER

(71) Applicant: Osama Shehata, Fairfax, VA (US)

(72) Inventor: Osama Shehata, Fairfax, VA (US)

(21) Appl. No.: 15/881,126

(22) Filed: Jan. 26, 2018

Related U.S. Application Data
(60) Provisional application No. 62/450,733, filed on Jan. 26, 2017.

(51) Int. Cl. G06Q 30/06

(52) U.S. Cl. CPC G06Q 30/0607; G06Q 30/0609

(57) ABSTRACT

In an approach to verifying the requirements for a vehicle purchase, evaluating the requirements for authorizing the registration of a vehicle and the authentication of an owner, collecting content associated with the registration of the vehicle and content associated with the authentication of the owner, processing the content with a governing body's regulations, wherein it is determined if errors exist between the regulations and the content, translating errors from the statutory requirement to a plain English format, generating a report presenting the processed new content and the processed content, receiving content, wherein the content corrects the errors discovered in the content, and processing the content with the new content with the governing body's regulations, to determine if the errors are corrected.

The current application claims a priority to the U.S. Provisional Patent application Ser. No. 62/450,733 filed on Jan. 26, 2017.

### BACKGROUND

This disclosure relates generally to a method for examining vehicles and customer records at a motor vehicle administration and converting the examination results into a human-readable format. By utilizing the present invention, the dealership and a customer who purchased a vehicle from the dealership can share, collaborate, and update information related to registering the purchased vehicle and the issuance of a permanent license plate and registration.

In almost every automotive dealership, there exist at least three major departments. Namely, a sales department, a finance and insurance (F&I) department, and the tags and title department. The sales department consist of sales consultants and sales managers. The main responsibility of both the consultants and sales managers is to negotiate sales and to make sure that each business deal closes. The F&I department consists of one or more finance managers and a finance director. Their main responsibility is to secure funding for the buyer who wishes to finance the price of their prospective vehicle and issue temporary or permanent license plates (tags) with a registration. Upon the completion of the transaction, the staff member sends the buyer's folder to the tag & title department. The tag and title department consist of one or more person. The main responsibility is to receive the documentations from the F&I staff member and prepare the necessary forms required by the Department of Motor Vehicle (DMV) to register his or her vehicle.

When a dealership sells a vehicle, the sales department prepares the necessary paper work and sends the folder containing all the documents to the F&I staff member. Once the F&I staff member secures the financing and/or collects the fund for the price of the vehicle, he or she will issue, (in some cases) a temporary tag for the buyer which is valid for 30 days from the date of sale or issuing date. At this point, the buyer is leaving the dealership with his or her vehicle and has no other means of knowing when and how he or she will receive the permanent tags and registration, nor the dealership personnel.

While the dealership has collected the necessary documents from the buyer to register the vehicle in his or her name, there may be an issue with the buyer's record at the DMV preventing the tag & title department from moving forward with the process. For example, if the buyer has an outstanding ticket (moving violation or parking ticket) that is unpaid, this will stop the process, and therefore, the tag & title department has to reach to the buyer to resolve this issue prior to moving forward.

Furthermore, there may be an issue with the vehicle's specifications recorded at the DMV that will prevent the tag & title department from registering the vehicle to the buyer's name. For example, if the vehicle is pre-owned and has been registered previously in a different state with a specification indicating a high-level of tinted windows, then it may be violating the guidelines for the new buyer's state DMV and therefore the dealership will not be able to move forward with the process of registering the vehicle in the new buyer's name.

The normal process is that the tag & title department at the dealership will receive the sold vehicle folder from the sales department or the F&I staff, and then prepare the required forms and documentation for registering the sold vehicle and obtaining the registration and permanent tags.

The preparation of the documents takes time, and in the best-case scenario, the process will take between one to three weeks. Moreover, the tag & title department will not start the preparation process until the funding price of the vehicle has cleared into the dealership's bank account. For example, if the buyer pays for the vehicle by personal check, the tag & title department will have to wait 10 days until they initiate the process, and when the buyer finances the price of the vehicle then, the tag & title department also has to wait again until the financial institution funds the finance contract, and the fund is cleared into the dealership bank account.

Generally, the waiting period between the time when the tag & title department receive the buyer's form and initiating the process of registering the vehicle is not less than two weeks. After the two weeks period, the tag & title department will initiate the process if the buyer's DMV state is the same state where the dealership is located. However, if the buyer will register the vehicle in a state different from the dealership state then, the tag & title department will have to mail all the forms and documentation to a third-party company who will handle the process on behalf of the dealership for a fee. The third-party company will initiate the process once they receive the package by mail.

In either case; the buyer's forms and documentations will be sent to a DMV for at least two weeks from the date of sale which is the same date F&I department issued the temporary tags. This leaves the dealership with a very limited time to supply the permanent tags and registration.

The manual, slow process and broken system is a massive burden on the tag & title department, and it is even a problematic to the dealership. For example, it is a major issue when the buyer's documentations and forms are sent to a DMV and then rejected for the reasons like; issues with the sold vehicle, issues with the buyer record, and/or missing documentation. This will delay supplying the permanent tags and registration to the buyer.

Since the buyer paid for the vehicle together with the registration fees, he or she expects the dealership to supply the permanent tags and registration on time. The problem arises at the time when the buyer learns two or three weeks later that there is an issue that preventing the dealership from supplying his or her tags and registration. The dealership in this case has to issue a new set of temporary tags for the buyer as the 30 days are about to expire. It is only at this point that the buyer will discover that there are issues preventing them from registering the vehicle in his or her name.

The situation gets even more problematic in some states who do not allow automotive dealerships to issue a second set of temporary tags for their buyers if they were not able to register the sold vehicle and obtain permanent tags within 30 days. Therefore, the buyer needs to personally go to a local DMV and apply for a second set of temporary tags while the dealership completes the process.

During all these delay processes, and after the late discovery of issues preventing the dealership to register the vehicle, the tag & title department will continue to prepare other additional requirements. In the meantime, the buyer will be worried, contacting the dealership multiple times and asking them when he or she will receive his or her registration and permanent tags.

The buyer will obviously contact the sales representative in this case, however, because the sales representative has no access to the title & tags department, the sales representative answer will be “I do not know” and will have to transfer the buyer to the sales manager since the sales managers are responsible for selling of vehicles, managing sales, and resolving issues. They too have no access to the tag & title department, and therefore need to either investigate the matter then call the buyer later, or come up with an acceptable excuse to prolong the buyer waiting time until they find out the update on his or her registration and permanent tags from the tag & title department.

If this issue occurs during the weekend or holiday time, while the tag & title department staff members are off duty, it will take a longer time to answer the request of the buyer or provide him or her with an update on the registration progress.

In the case where additional documentations are needed from the buyer, often times, he or she will send the required document(s) to one of the staff member, fax them to the main dealership's fax number, or bring them in person to the dealership. The tag & title department usually do not receive documents directly and the documents are often misplaced or lost. However, because the tag & title department is not being informed that the buyer has brought the required documents or have satisfied all the requirements, they will continue to contact the buyer asking him or her for the same requirement.

Furthermore, when a buyer sends any additional required document to the dealership, they are sometime received by a different office or staff member at the dealership than the tag & title department, said documents not necessarily sent to the tag & title department on time. This type of action causes confusion and discrepancy, as the F&I may issue a permanent tags and registration based on receiving some of the documentation while the tag & title department does the same, resulting in registering the vehicle two times.

So, in almost every dealership, communication between the dealership F&I, the tag & title department, the DMV, and the buyer is always a serious challenge. As the temporary tags are valid for only 30 days from the issue date, the buyer will naturally call the dealership asking when his or her permanent tag will be issued, which will lead the buyer to be transferred from one staff member to the other.

The whole process creates confusion, frustration, and dissatisfaction for the buyer. It will also place the dealership in a legal situation when personal buyers' information, such as social security, driver's license number or the like, are lost or get in the hands of unauthorized persons in the dealership.

It is therefore, an objective of the present invention to provide a platform structured marking method and system for examining vehicles and buyers' records at the Department of Motor Vehicle (DMV), sharing, collaborating, and updating both, the dealerships and their buyers with any issues preventing the dealership from completing the process of the vehicle registration and the supply of permanent tags.

### SUMMARY

A first aspect of the present invention provides a method for verifying the requirements for a vehicle purchase. Wherein evaluating the requirements for authorizing the registration of a vehicle and the authentication of an owner, collecting a first set of content associated with the registration of the vehicle and a second set of content associated with the authentication of the owner, processing the first set of content and the second set of content with a governing body's regulations, wherein it is determined if errors exist between the regulations and the first set of content or the second set of content, translating errors from the statutory requirement to a plain English format, generating a report presenting the processed first set of content and the processed second set of content, receiving a third set of content, wherein the third set of content corrects the errors discovered in the first set of content and the second set of content, and processing, the first set of content and the second set of content with the third set of content with the governing body's regulations, to determine if the errors are corrected.

A second aspect of the present invention provides a computer program product for verifying the requirements for a vehicle purchase. Wherein evaluating the requirements for authorizing the registration of a vehicle and the authentication of an owner, collecting a first set of content associated with the registration of the vehicle and a second set of content associated with the authentication of the owner, processing the first set of content and the second set of content with a governing body's regulations, wherein it is determined if errors exist between the regulations and the first set of content or the second set of content, translating errors from the statutory requirement to a plain English format, generating a report presenting the processed first set of content and the processed second set of content, receiving a third set of content, wherein the third set of content corrects the errors discovered in the first set of content and the second set of content, and processing, the first set of content and the second set of content with the third set of content with the governing body's regulations, to determine if the errors are corrected.

A third aspect of the present invention provides a computer system for verifying the requirements for a vehicle purchase. Wherein evaluating the requirements for authorizing the registration of a vehicle and the authentication of an owner, collecting a first set of content associated with the registration of the vehicle and a second set of content associated with the authentication of the owner, processing the first set of content and the second set of content with a governing body's regulations, wherein it is determined if errors exist between the regulations and the first set of content or the second set of content, translating errors from the statutory requirement to a plain English format, generating a report presenting the processed first set of content and the processed second set of content, receiving a third set of content, wherein the third set of content corrects the errors discovered in the first set of content and the second set of content, and processing, the first set of content and the second set of content with the third set of content with the governing body's regulations, to determine if the errors are corrected.

### BRIEF DESCRIPTION OF THE DRAWINGS

FIG. 1 depicts a block diagram depicting a computing environment, in accordance with one embodiment of the present invention.

FIG. 2 depicts a flowchart of the operational steps taken by verification program to process the customer and vehicle information within the computing environment of FIG. 1, in accordance with an embodiment of the present invention.

FIG. 3 depicts a block diagram depicting the internal and external components of the server of FIG. 1, in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

The present invention introduces a method for examining and evaluating vehicle information and customer information when the process of issuing a permanent license plate takes place. By utilizing the present invention, the customer who purchased a vehicle and the dealership that sold the vehicle are constantly notified regarding the status of the process. Thus, any confusion and inconvenience that can occur between the customer, the dealership, and the department of motor vehicles is eliminated.

The present invention will now be described in detail with reference to the Figures.

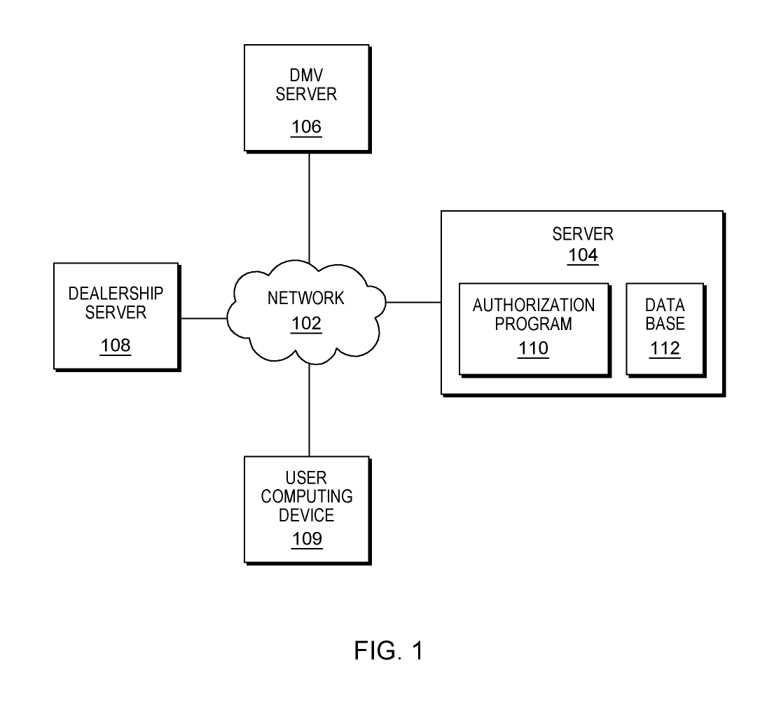

FIG. 1 depicts a block diagram of a computing environment 100 in accordance with one embodiment of the present invention. FIG. 1 provides an illustration of one embodiment and does not imply any limitations regarding the environment in which different embodiments maybe implemented.

In the depicted embodiment, computing environment 100 includes network 102, server 104, DMV server, dealership server 108, and user computing device 109. Computing environment 100 may include additional servers, computers, or other devices not shown.

Network 102 may be a local area network (LAN), a wide area network (WAN) such as the Internet, any combination thereof, or any combination of connections and protocols that can support communications between server 104, DMV server, dealership server 108, and user computing device 109 in accordance with embodiments of the invention. Network 102 may include wired, wireless, or fiber optic connections.

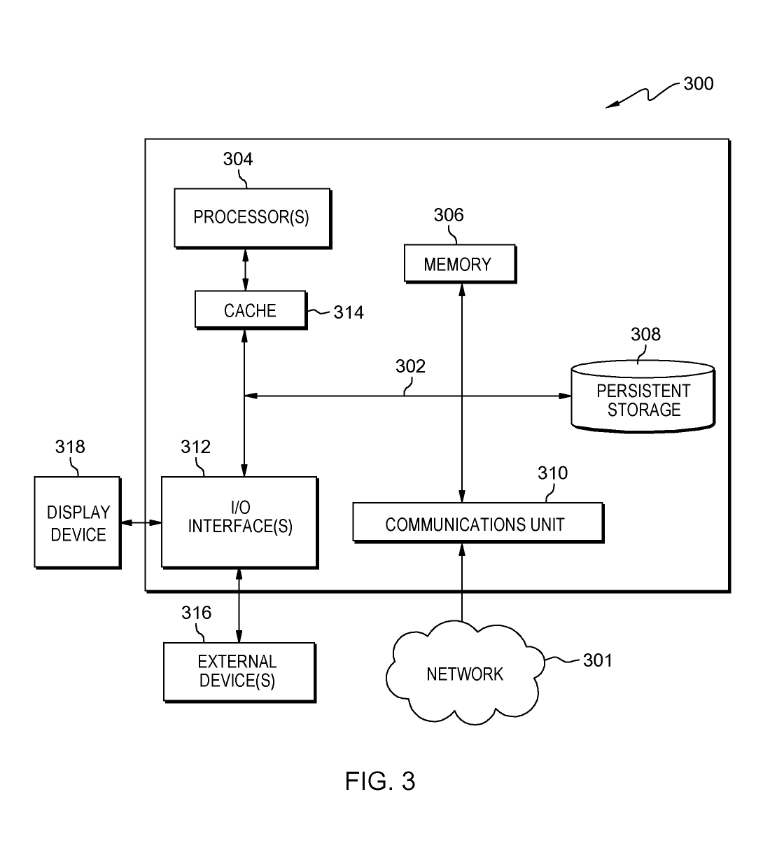

Server 104, DMV server, dealership server 108 may be a management server, a web server, or any other electronic device or computing system capable of processing program instructions and receiving and sending data. Server 104 stores the program and the data for processing with the required entities. In one embodiment, server 104, DMV server, dealership server 108, and user computing device 109 may be a laptop computer, tablet computer, netbook computer, personal computer (PC), a desktop computer, or any programmable electronic device capable of communicating via network 102. In one embodiment, server 104, DMV server, dealership server 108, and user computing device 109 may be a server computing system utilizing multiple computers as a server system, such as in a cloud computing environment. In one embodiment, server 104, DMV server, dealership server 108, and user computing device 109 represents a computing system utilizing clustered computers and components to act as a single pool of seamless resources. In the depicted embodiment authorization program 110 and database 112 are located on server 104. In additional embodiments, authorization program 110 and database 112 may be located on other servers or computing devices, provided server 104 is able to communicate server 104, DMV server, dealership server 108, user computing device 109, authorization program 110, and database 112 via network 102. In additional embodiments, server 104 may include components, as depicted and described in further detail with respect to FIG. 3.

DMV server 106 may be a management server, a web server, or any other electronic device or computing system capable of processing program instructions and receiving and sending data. DMV server 106 is used to gather and process vehicle and customer information based on the DMV requirements and procedures. In one embodiment, DMV server 106 may be a laptop computer, tablet computer, netbook computer, personal computer (PC), a desktop computer, or any programmable electronic device capable of communicating via network 102. In one embodiment, DMV server 106 may be a server computing system utilizing multiple computers as a server system, such as in a cloud computing environment. In one embodiment, DMV server 106 represents a computing system utilizing clustered computers and components to act as a single pool of seamless resources. In additional embodiments, one or both of authorization program 110 and database 112 may be located on other servers or computing devices, provided DMV server 106 is able to communicate with server 104, dealership server 108, user computing device 109, authorization program 110, and database 112 via network 102. In additional embodiments, DMV server 106 may include components, as depicted and described in further detail with respect to FIG. 3.

Dealership server 108 may be a management server, a web server, or any other electronic device or computing system capable of processing program instructions and receiving and sending data. Dealership server 108 is used by the dealership to gather, send, receive, and process the customers materials and the vehicle materials. In one embodiment, dealership server 108 may be a laptop computer, tablet computer, netbook computer, personal computer (PC), a desktop computer, or any programmable electronic device capable of communicating via network 102. In one embodiment, dealership server 108 may be a server computing system utilizing multiple computers as a server system, such as in a cloud computing environment. In one embodiment, dealership server 108 represents a computing system utilizing clustered computers and components to act as a single pool of seamless resources. In additional embodiments, one or both of authorization program 110 and database 112 may be located on dealership server 108 or computing devices, provided dealership server 108 is able to communicate server 104, DMV server 106, user computing device 109, authorization program 110, and database 112 via network 102. In additional embodiments, dealership server 108 may include components, as depicted and described in further detail with respect to FIG. 3.

Customer computing device 109 may be any electronic device or computing system capable of processing program instructions, receiving and sending data. In some embodiments, customer computing device 109 may be a laptop computer, tablet computer, netbook computer, personal computer (PC), a desktop computer, or any programmable electronic device capable of communicating with server 104, dealership server 108, or DMV server 106 via network 102. In other embodiments, customer computing device 109 may represent a server computing system utilizing multiple computers as a server system, such as in a cloud computing environment. In another embodiment, customer computing device 109 represents a computing system utilizing clustered computers and components to act as a single pool of seamless resources. In additional embodiments, customer computing device 109 may house one or both of authorization program 110 and database 112 provided customer computing device has access to network 102. Customer computing device 109 may include components, as depicted and described in further detail with respect to FIG. 3.

Authorization program 110 perform the analysis of the vehicle status and information and the customer information to the DMV procedures and requirements for an automobile or motorized vehicle to be issued the proper documentation to be registered and allowed on the request roadways. In the depicted embodiment, authorization program 110 utilizes network 102 to access the DMV server 106, the dealership server 108, customer computing device 109, and database 112 to gather, process, and report the allowance the of vehicle registration, and customer function 114 and vehicle function 116 are part of authorization program 110. In additional embodiments, authorization program 110 may be located on another server or computing device, provided authorization program 110 has access to DMV server 106, the dealership server 108, customer computing device 109, and database 112.

Database 112 may be a repository that may be written to and/or read by authorization program 110. Information gathered from authorization program 110 may be stored to database 112. Such information may include customer information, vehicle information, DMV procedures and processes, dealership data, and the like. In one embodiment, database 112 is a database management system (DBMS) used to allow the definition, creation, querying, update, and administration of a database(s). In the depicted embodiment, database 112 resides on server 104. In other embodiments, database 112 resides on another server, or another computing device, provided that database 112 is accessible to authorization program 110 through network 102.

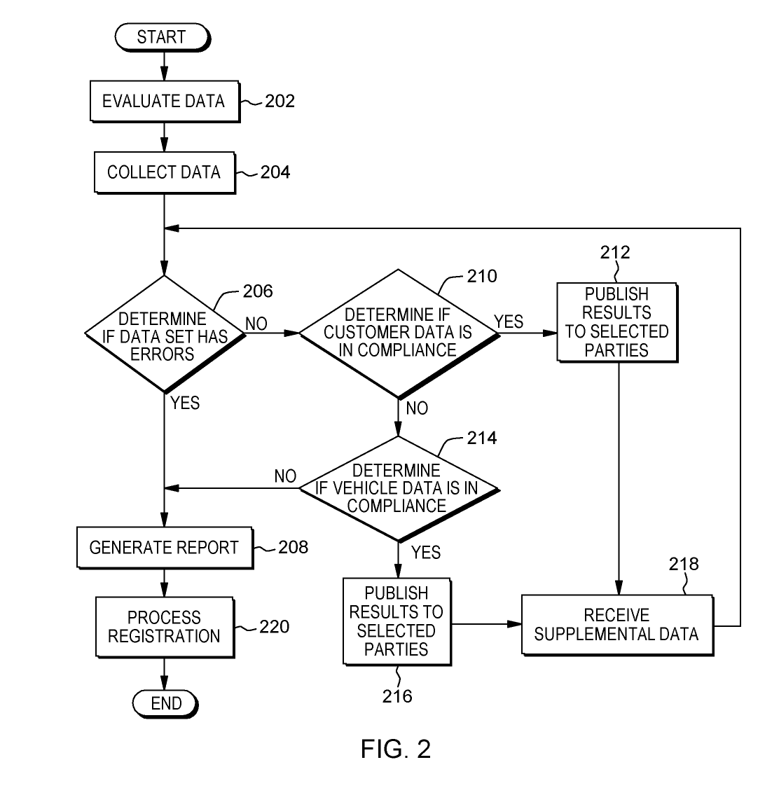

FIG. 2 shows flowchart 200 depicting a method according to the present invention. The method(s) and associated process(es) are now discussed, over the course of the following paragraphs, with extensive reference to FIG. 2, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The authorization program 110 streamlines the process of having an automobile or motorized vehicle registered in the desired location based on local, state, and federal laws and regulations. The authorization program 110 reduces the involvement of the numerous parties to assist in decreasing the time from the purchasing of the motorized vehicle to the time it is able to be registered to the buyer's name and the supply of permanent license plates and registration.

In step 202, authorization program 110 evaluates the laws. Authorization program 110 evaluates, and analyzes local, state, and federal agency(es) or department(s) (hereinafter “governing body), to compile with the requirements to register a vehicle under that governing body. These laws are based on what is required to properly adhere to the requirements for both the vehicle and driver when registering a vehicle for road use. For example, the requirements to pass the examination and verification, thereby allow for an improved and simplified issuing of the license plates and the registration documents for the vehicle. In some embodiments, the authorization program 110 communicates with the agencies or departments which would be involved in the registration of a vehicle within the specific state or territory and collect statues, laws, or regulations that would be used to pass a vehicle and a customer when registering a vehicle. The collection of the statutes, laws, regulations, or modifications to these may be performed by the authorization program 110, or a third party. With laws, and regulations changing with safety and security as well as environmental changes, authorization program 110 updates and adjusts the data stored on database 112 related to this material. In some embodiments, authorization program 110 complies with multiple state agencies and requirements for transactions which occur over state lines. In additional embodiments, authorization program 110 substantially continuously or at predetermined intervals updates and adjusts the requirements for the vehicle and customer. The evaluation may be performed internally through the authorization program 110 or through a third-party application programming interface (API).

In step 204, authorization program 110 collects data. The authorization program 110 collects information about the vehicle, the customer, which is required by the governing body(es) to approve the vehicle and customer for registration. In one embodiment, the information is submitted directly to the DMV server 106 for processing. In some embodiments, authorization program 110 process the information to determine if it is complete and then submits the information to the DMV server 106. In additional embodiment, authorization program 110 processes the information before submission to the DMV server 106. In some embodiments, the information is collected manually or by a third party. The information necessary to process the vehicle and the customer to legally and safely operate the vehicle on publicly used roadways is provided to the dealership and/or the customer to input the requested information. Authorization program 110 may modify the interface and fields which the parties are to input information into based on the adjustment of the governing body requirements. The vehicle information may be, but not limited to, the make, model, year, mileage, accident history, repair history, inspection results, vehicle identification number (VIN), information specific to the dealer or seller, temporary registration information, and the like which would be used to confirm proper operating conditions of the vehicle. The customer information, may include, but not limited to the customers, name, address, driver license number, driving abstract/record, insurance, contact information, or other information associated with the customer's ability to legally operate a motor vehicle. In some embodiments, the customer is assigned a unique identification number to assist the dealership in monitoring and controlling the customer applications. In some embodiments, the authorization program 110 gathers the necessary information from information stored on database 112 gathered by a third party, or the authorization program 110. This information may be stored on dealership server 108, server 104, or customer computing device 109.

In decision 206, authorization program 110 determines if there are errors with the collected data set. Authorization program 110 compares the collected data with the requirements to make a determination of all the information is present, and within the threshold, maxes, or minimums of the laws. In additional embodiments, authorization program 110 receives a response from the DMV server if the information is correct or has errors, and additional information about those errors. For example, if the customer is allowed to have so many points on their license, if their insurance covers the value of the vehicle, if the vehicle has proper inspection, is the vehicle is road legal (e.g. tint, exhaust, make, model), or the like. If authorization program 110 determines if the data set is in compliance with the evaluated laws, (YES branch, proceed to step 210) authorization program 110 generates a result report. If authorization program 110 determined that the information is not incompliance with the governing body requirements, (NO branch, proceed to decision 210) authorization program 110 determined if the issue is with the customer information. In some embodiments, authorization program 110, is substantially continuously monitoring the governing body requirements, and is able to adjust the determination at the instance of the request.

In step 208, authorization program 110 generates a result report. The result report shows that the vehicle and the customer have achieves the minimum requirements for the vehicle to be registered by the governing body. This report is provided to a predetermined set of parties, e.g. the dealership, the customer, or both. In additional embodiments, additional information may be incorporated to provide additional insight the parties which receive the report for future reference, such as, when the next inspection is, condition of systems or parts of the vehicle.

In decision 210, authorization program 110 determines if the customer data is the cause of the error. Authorization program 110 through analyzing the governing body requirements, and the information collected by the customer, dealership, or a third party is either incomplete, or if there is an issue or error with the information input, e.g. incorrect address, driver's abstract showing to many points, misspelled name, or information which is not incompliance with the governing body. The authorization program 110 determines that the customer data is not in compliance (YES branch, proceed to step 212) the authorization program 110 publishes the causes to the selected parties. If the authorization program 110 determines that the customer data is in compliance, (NO branch, proceed to decision 214) authorization program 110 determines if the vehicle information is the cause for the error. In some embodiments, the customer data is marked or tagged. The marking or tagging maybe to the section of the data which is incorrect or improper.

In step 212, authorization program 110 publishes the causes for the failed compliance check. The authorization program 110 through the analysis of the governing body requirements, laws, procedures, statutes, and the like is able to consolidate the relevant materials, transcribe the materials into a structure and layout which would provide beneficial, helpful, and understandable by the parties, and present the predetermined parties with the report. This may mean writing out the cause of the rejection or failure in plain English. Many times, laws and statuary regulations are written in a way that is difficult to understand, thus authorization program 110 publishes a report for the predetermined parties that is simplified and directly address the error to assist in reducing the time to correct the error. In the depicted embodiment, the authorization program 110 publishes the causes for the failed compliance check to the customer and the dealership. This assist both parties in sorting out the errors and furthering the registration process. In some embodiments, the publication provides direct contact to specific governing body departments to allow for quicker clarification of the errors if additional assistance is necessary. For example, if the statutory code is INS-VOL, this will be transcribed to “the system has found an issue with the customer's record, the customer has an insurance violation and therefore must provide the following information prior to moving forward”, and additional information which may be helpful to the dealership or the customer The results may inform the customer or dealership how to correct the errors if in-person meeting with the governing body is required.

In decision 214, authorization program 110 determines if the vehicle data is the cause of the error. Authorization program 110 through analyzing the governing body requirements, and the information collected about the vehicle by the customer, dealership, or a third party is either incomplete, or if there is an issue or error with the information input, e.g. no inspection, incorrect year, make, or model, or known mechanic errors with the vehicle, or information which is not incompliance with the governing body. The authorization program 110 determines that the vehicle data is not in compliance (YES branch, proceed to step 216) the authorization program 110 publishes the results to the selected parties. If the authorization program 110 determines that the vehicle data is in compliance, (NO branch, proceed to decision 208) authorization program 110 generates the report. In an instance where the authorization program 110 locates an error, but when further review of the customer and vehicle information establishes there is no error, this may be due to a change in the requirements by the governing body or information may have been updated by the customer, dealership, or a third party during the process. In some embodiments, the correct data is marked so that the dealership is able to delineate from the correct and incorrect data.

In step 216, authorization program 110 publishes the report to the selected parties. The authorization program 110 through the analysis of the governing body requirements, laws, procedures, statutes, and the like is able consolidate the relevant materials, transcribe the materials into a structure and layout which would provide beneficial and helpful to the parties, and present the predetermined parties with the report. Many times, laws and statuary regulations are written in a way that is difficult to understand, thus authorization program 110 publishes a report for the predetermined parties that is simplified and directly address the error to assist in reducing the time to correct the error. In the depicted embodiment, the authorization program 110 publishes the causes for the failed compliance check to the dealership only. This assist both parties in sorting out the errors and furthering the registration process. In some embodiments, the publication provides direct contact to specific governing body departments to allow for quicker clarification of the errors if additional assistance is necessary.

In step 218, authorization program 100 receives supplemental materials. Once the publications of the errors are sent to the respective parties, these parties or a third party may supply supplemental materials that update the existing information or supply additional information which could be used to correct the cause of the errors. In some embodiments, the dealership is provided with the request for supplemental materials, as they may be more prone to respond with the desires materials. In some embodiments, authorization program 110 selected the supplemental materials based on an analysis and assessment of the publication. Authorization program 110 may have cognitive computing technology to allow for the analysis of the publication, determine of the laws, and the ability to substantially automatically select materials which would most likely solve the failure. In some embodiments, authorization program 110 receives these submissions and re-determines if the information is in compliance with the requirements. In some embodiments, the authorization program 110 re-evaluates the governing body requirements. In additional embodiments, authorization program 110 alerts the inputting party if the supplemental materials will correct the error(s) or if additional information is further necessary.

In step 220, authorization program 110 processes the vehicle registration. Once the vehicle and customer are in compliance with the governing body requirements, the authorization program 110 processes the registration of the vehicle. This process, may include submitting the necessary information to the governing body to produce the plates and registration and mail to the desired party. In additional embodiments, the dealership may have proper authority and equipment to process the plates and registration on site. This will alleviate the need for a temporary plate and registration for the customer.

In some embodiments, the customer and the dealership are able to view the current status of the process. If the customer prefers to view the current status of the process, the present invention prompts the customer. When processing the customer's information, the present invention displays the case evaluation associated with the customer. By viewing the plurality of customer information and the plurality of vehicle information the customer can ensure that all the required documents have been uploaded onto the server prior to being notified by the present invention. The uploaded documents are also analyzed to confirm that they provide the required information, and if so that, the information provided satisfies the requirements. Similar to the customer account, the dealership account can also view the current status of the process of issuing the permanent license plate. The present invention displays the case evaluation associated with the customer, and generated through the DMV. By viewing the plurality of customer information and the plurality of vehicle information the dealership can ensure that all the required documents have been uploaded onto the server prior to being notified by the present invention. The uploaded documents are also analyzed to confirm that they provide the required information, and if so that, the information provided satisfies the requirements.

In addition to viewing the current status, the present invention also allows the customer and the dealership to view a history of the process of issuing the permanent license plate. To do so, the present invention is provided with a transaction history report which is associated with the customer. Thus, for each vehicle that is sold through the dealership, a new transaction history reported is generated on the at least one remote server. When the transaction history needs to be viewed, the present invention receives a viewing request which is associated with the customer. The present invention then proceeds to match the customer with the transaction history report on the at least one remote server containing the customer. Upon discovering the transaction history report containing the customer, the present invention displays the transaction history report.

In some embodiments, the system is set for a predetermined time frame to search for updated data. This may be, for example, a 24-hour period where each night or morning the system searches for updated customer or vehicle data to determine if the new data is proper. In additional embodiments, one or more party may be alerted at each step of the process, so that the parties can stay informed of what is happening so that if there is an error or issue, it can easily and quickly be addresses.

FIG. 3 depicts a block diagram 300 of components of a computing device (e.g. computing device 104, personnel computing device 106, or server 108), in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made. It should be appreciated FIG. 1 provides only an illustration of one implementation and does not imply any limitations with regard to the environments in which different embodiments may be implemented.

Computing environment 300 is, in many respects, representative of the various computer subsystem(s) in the present invention. Accordingly, several portions of computing environment 300 will now be discussed in the following paragraphs.

Computing device 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any additional hardware components within a system. For example, communications fabric 302 can be implemented with one or more buses.

Computing device 300 is capable of communicating with other computer subsystems via network 301. Network 301 can be, for example, a local area network (LAN), a wide area network (WAN) such as the Internet, or a combination of the two, and can include wired, wireless, or fiber optic connections. In general, network 301 can be any combination of connections and protocols that will support communications between computing device 300 and other computing devices.

Memory 306 and persistent storage 308 are computer-readable storage media. In one embodiment, memory 306 includes random access memory (RAM) and cache memory 314. In general, memory 306 can include any suitable volatile or non-volatile computer-readable storage media.

Memory 306 is stored for execution by one or more of the respective computer processors 304 of computing device 300 via one or more memories of memory 306 of computing device 300. In the depicted embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in the examples, provides for communications with other data processing systems or devices, including computing device 300. In the examples, communications unit 310 includes one or more network interface cards. Communications unit 310 may provide communications through the use of either or both physical and wireless communications links.

I/O interface(s) 312 allows for input and output of data with other devices that may be connected to computing device 300. For example, I/O interface 312 may provide a connection to external devices 316 such as a keyboard, keypad, camera, a touch screen, and/or some other suitable input device. External devices 316 can also include portable computer-readable storage media such as, for example, thumb drives, portable optical or magnetic disks, and memory cards. Software and data used to practice embodiments of the present invention, e.g., regulation program 420 can be stored on such portable computer-readable storage media and can be loaded onto persistent storage 308 of computing device 300 via I/O interface(s) 312 of computing device 300. Software and data used to practice embodiments of the present invention, e.g., regulation program 420 can be stored on such portable computer-readable storage media and can be loaded onto persistent storage 308 of computing device 300 via I/O interface(s) 312 of computing device 300. I/O interface(s) 312 also connect to a display 318.

Display 318 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the computer, partly on the computer, as a stand-alone software package, partly on the computer and partly on a remote computer or entirely on the remote computer or server. In the latter scenario, the remote computer may be connected to the computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

What is claimed is:

1. A method for verifying the requirements for a vehicle purchase, the method comprising:
evaluating, by one or more processors, the requirements for authorizing the registration of a vehicle and the authentication of an owner;
collecting, by one or more processors, a first set of content associated with the registration of the vehicle and a second set of content associated with the authentication of the owner;
processing, by one or more processors, the first set of content and the second set of content with a governing body's regulations, wherein it is determined if errors exist between the regulations and the first set of content or the second set of content;
translating, by one or more processors, errors from the statutory requirement to a plain English format;
generating, by one or more processors, a report presenting the processed first set of content and the processed second set of content;
receiving, by one or more processors, a third set of content, wherein the third set of content is used to correct errors discovered in the first set of content and the second set of content;
processing, by one or more processors, the first set of content and the second set of content with the third set of content, to determine errors with the first set of content and the second set of content; and
reporting, by one or more processors, the errors and viable corrections for those errors.

2. The method for verifying the requirements for a vehicle purchase of claim 1 further comprising: analyzing, by one or more processors, the governing body's regulations associated with the location of the vehicle and owner related to the requirements.

3. The method for verifying the requirements for a vehicle purchase of claim 1, wherein, it is determined that a portion of the second set of content is incorrect, further comprising, informing, by one or more processors, the owner, if the second set of content produces errors in relation to the regulations.

4. The method for verifying the requirements for a vehicle purchase of claim 1, wherein, it is determined that a portion of the first set of content is incorrect, further comprising, informing, by one or more processors, a dealership, if the first set of content produces errors in relation to the regulations.

5. The method for verifying the requirements for a vehicle purchase of claim 1, wherein, the processing of the first set of content and the second set of content with the third set of content, combining, by one or more processors, predetermined portions of the third set of data with the first set of content and the second set of content.

6. The method for verifying the requirements for a vehicle purchase of claim 1, further comprising contacting, by one or more processors, a governing body department for updated status on the authorizing of the registration and the authentication of the owner at a predetermined interval.

7. The method for verifying the requirements for a vehicle purchase of claim 1, compiling, by one or more processors, a substantial portion of the requirements setforth by the governing body to register a vehicle and authorize an owner.

8. A computer program product for verifying the requirements for a vehicle purchase, the method comprising:
one or more computer readable storage media and program instructions stored on the one or more computer readable storage media, the program instructions comprising:
program instructions to evaluate the requirements for authorizing the registration of a vehicle and the authentication of an owner;
program instructions to collect a first set of content associated with the registration of the vehicle and a second set of content associated with the authentication of the owner;
program instructions to process the first set of content and the second set of content with a governing body's regulations, wherein it is determined if errors exist between the regulations and the first set of content or the second set of content;
program instructions to translate errors from the statutory requirement to a plain English format;
program instructions to generate a report presenting the processed first set of content and the processed second set of content;
program instructions to receive a third set of content, wherein the third set of content corrects the errors discovered in the first set of content and the second set of content; and
program instructions to process the first set of content and the second set of content with the third set of content with the governing body's regulations, to determine if the errors are corrected.

9. The computer program product of claim 8, further comprising, computer instructions to analyze the governing body's regulations associated with the location of the vehicle and owner related to the requirements.

10. The computer program product of claim 8, wherein, it is determined that a portion of the second set of content is incorrect, further comprising, computer instructions to inform the owner, if the second set of content produces errors in relation to the regulations.

11. The computer program product of claim 8, wherein, it is determined that a portion of the first set of content is incorrect, further comprising, computer instructions to inform a dealership, if the first set of content produces errors in relation to the regulations.

12. The computer program product of claim 8, wherein, the processing of the first set of content and the second set of content with the third set of content, further comprising, computer instructions to combine predetermined portions of the third set of data with the first set of content and the second set of content.

13. The computer program product of claim 8, further comprising, computer instructions to contact a governing body department for updated status on the authorizing of the registration and the authentication of the owner at a predetermined interval.

14. The computer program product of claim 8, further comprising computer instructions to compile a substantial portion of the requirements setforth by the governing body to register a vehicle and authorize an owner.

15. A computer program product for verifying the requirements for a vehicle purchase, the method comprising:
one or more computer processors, one or more computer readable storage media, and program instructions stored on the one or more computer readable storage media for execution by, at least one of the one or more processors, the program instructions comprising:
program instructions to evaluate the requirements for authorizing the registration of a vehicle and the authentication of an owner;
program instructions to collect a first set of content associated with the registration of the vehicle and a second set of content associated with the authentication of the owner;
program instructions to process the first set of content and the second set of content with a governing body's regulations, wherein it is determined if errors exist between the regulations and the first set of content or the second set of content;
program instructions to translate errors from the statutory requirement to a plain English format;
program instructions to generate a report presenting the processed first set of content and the processed second set of content;
program instructions to receive a third set of content, wherein the third set of content corrects the errors discovered in the first set of content and the second set of content; and
program instructions to process the first set of content and the second set of content with the third set of content with the governing body's regulations, to determine if the errors are corrected.

16. The computer system of claim 15, further comprising, computer instructions to analyze the governing body's regulations associated with the location of the vehicle and owner related to the requirements.

17. The computer system of claim 15, wherein, it is determined that a portion of the second set of content is incorrect, further comprising, computer instructions to inform the owner, if the second set of content produces errors in relation to the regulations.

18. The computer system of claim 15, wherein, it is determined that a portion of the first set of content is incorrect, further comprising, computer instructions to inform a dealership, if the first set of content produces errors in relation to the regulations.

19. The computer system of claim 15, wherein, the processing of the first set of content and the second set of content with the third set of content, further comprising, computer instructions to combine predetermined portions of the third set of data with the first set of content and the second set of content.

20. The computer system of claim 15, further comprising, computer instructions to contact a governing body department for updated status on the authorizing of the registration and the authentication of the owner at a predetermined interval.
